(19) United States
(12) Patent Application Publication
(10) Pub. No.: US 2009/0327969 A1
(43) Pub. Date: Dec. 31, 2009

(54) SEMANTIC ZOOM IN A VIRTUAL THREE-DIMENSIONAL GRAPHICAL USER INTERFACE

(75) Inventor: Julio Estrada, Medina, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/163,999

(22) Filed: Jun. 27, 2008

(51) Int. Cl. G06F 3/048

(52) U.S. Cl. 715/848

(57) ABSTRACT

A GUI adapted for use with portable electronic devices such as media players is provided in which interactive objects are arranged in a virtual three-dimensional space (i.e., one represented on a two-dimensional display screen). The user manipulates controls on the player to maneuver through the 3-D space by zooming and steering to objects of interest which can represent various types of content, information or interactive experiences. The 3-D space mimics real space in that close objects appear larger to user while distant objects appear smaller. The close objects will typically represent higher level content, information, or interactive experiences while the distant objects represent more detailed content, information, or experiences. This GUI navigation feature, referred to as a semantic zoom, makes it easy for the user to maintain a clear understanding of his location within the 3-D space at all times.

### BACKGROUND

Portable media players such as MP3 (Moving Pictures Expert Group, MPEG-1, audio layer 3) players, PDAs (personal digital assistants), mobile phones, smart phones, and similar devices typically enable users to interact with and consume media content such as music and video. Such players are generally compact and lightweight and operate on battery power to give users a lot of flexibility in choosing when and where to consume media content. As a result, personal media players have become widely accepted and used in all kinds of environments, including those where users are very active or out and about in their busy lifestyles. For example, when at the beach, a user might watch an episode of a favorite television show. The portable media player can then be placed in a pocket so that the user can listen to music while exercising, or when riding on the train back home.

Users typically utilize a graphical user interface (“GUI”) supported by a display screen that is incorporated into the player in order to navigate among various menus to make selections of media content, control operation of the portable media player, set preferences, and the like. The menus are organized in a hierarchical manner and the user will generally interact with user controls (e.g., buttons and the like) to move within a menu and jump to different menus to accomplish the desired functions.

While many current GUIs perform satisfactorily, it continues to be a challenge for developers to design GUIs that are easily and efficiently used, and engage the user in way that enhances the overall user experience. In particular, as portable media players get more onboard storage and support more features and functions, the GUIs needed to control them have often become larger and more complex to operate. For example, some current media players can store thousands of songs, videos, and photographs, play content from over the air radio stations, and enable shared experiences through device-to-device connections. Navigating through such large volumes of content and controlling the user experience as desired can often mean working through long series of hierarchical menus. Accordingly, GUIs that are more seamless in operation and intuitive to use and which provide a user with a better overall experience when interacting with the player would be desirable.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A GUI adapted for use with portable electronic devices such as media players is provided in which interactive objects are arranged in a virtual three-dimensional space (i.e., one represented on a two-dimensional display screen). The user manipulates controls on the player to maneuver through the 3-D space by zooming and steering to GUI objects of interest which can represent various types of content, information or interactive experiences. The 3-D space mimics real space in that close GUI objects appear larger to the user while distant objects appear smaller. The close GUI objects will typically represent higher-level content, information, or interactive experiences while the distant objects represent more detailed content, information, or experiences.

As the user flies along a desired path in the 3-D space to navigate between GUI objects by zooming and steering, distant objects appear in the space and become more detailed as they draw near. But unlike traditional hierarchical GUIs where the user typically jumps from menu to menu, the present GUI implements a continuous and seamless experience. Closer GUI objects on the display screen provide a semantic construct (i.e., contextual meaning) for the more distant objects that are simultaneously displayed. This GUI navigation feature, referred to as a semantic zoom, makes it easy for the user to maintain a clear understanding of his location within the 3-D space at all times. The semantic zoom is characterized by transitions between the close and distant objects that are dependent on the context level of the zoom. Simple and intuitive user control manipulation allows the user to steer to GUI objects while zooming in, or back up along the path to revisit objects and then navigate to other distant objects in the 3-D space.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative usage environment in which a user may listen to audio content and watch video content rendered by an illustrative portable media player;

FIG. 2 shows front view of an illustrative portable media player supporting a GUI on a display screen as well as user controls;

FIG. 3 shows a typical hierarchical arrangement by which a user may navigate among various menus to make selections of media content, control operation of the portable media player, set preferences, and the like;

FIG. 4 shows an illustrative arrangement of GUI objects in a virtual 3-D space;

FIG. 5 is a diagram indicating illustrative operations of the user controls when using the present semantic zoom;

FIG. 6 shows an illustrative path by which a user navigates among GUI objects in the 3-D space;

FIG. 7 shows an illustrative arrangement where multiple 3-D spaces may be utilized by the present semantic zoom;

FIG. 8 shows an illustrative screen shot of an entry point into a 3-D space in which the present semantic zoom is utilized;

FIGS. 9-16 are various illustrative screens that show aspects of the present 3-D semantic zoom;

FIG. 17 shows how a user may back up along a path in a 3-D space and then navigate along a new path;

FIG. 18 is an illustrative screen that shows a destination along the new path;

FIG. 19 shows the portable media player when docked in a docking station that is operatively coupled to a PC and where the PC is connected to a media content delivery service over a network such as the Internet;

FIG. 20 is a simplified block diagram that shows various functional components of an illustrative example of a portable media player; and

FIG. 21 is a simplified block diagram that shows various physical components of an illustrative example of a portable media player.

Like reference numerals indicate like elements in the drawings. Elements are not drawn to scale unless otherwise indicated.

### DETAILED DESCRIPTION

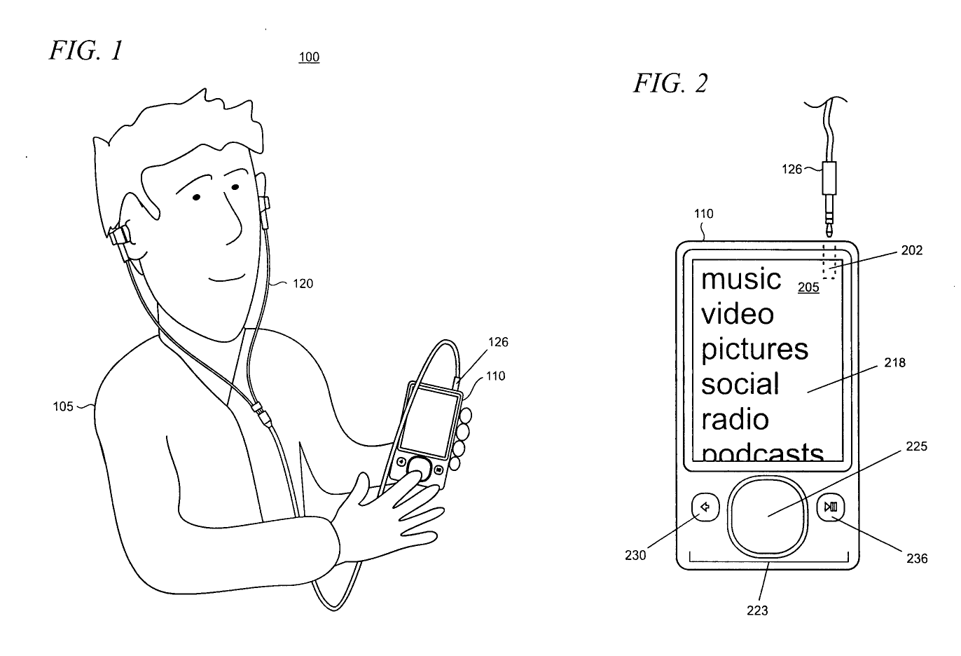

FIG. 1 shows an illustrative portable device usage environment 100 in which a user 105 interacts with digital media content rendered by a portable media player 110. In this example, the portable media player 110 is configured with capabilities to play audio content such as MP3 files or content from over-the-air radio stations, display video and photographs, and render other content. The user 105 will typically use earphones 120 to enable audio content, such as music or the audio portion of video content, to be consumed privately (i.e., without the audio content being heard by others) and at volume levels that are satisfactory for the user while maintaining good battery life in the portable media player. Earphones 120 are representative of a class of devices used to render audio which may also be known as headphones, earbuds, headsets, and by other terms. Earphones 120 generally will be configured with a pair of audio speakers (one for each ear), or less commonly a single speaker, along with a means to place the speakers close to the user's ears. The speakers are wired via cables to a plug 126. The plug 126 interfaces with a jack 202 in the portable media player 110, as shown in FIG. 2.

FIG. 2 also shows a conventional GUI 205 that is rendered on a display screen 218, and user controls 223 that are built in to the portable media player 110. The GUI 205 uses menus, icons, and the like to enable the user 105 to find, select, and control playback of media content that is available to the player 110. In addition to supporting the GUI 305, the display screen 218 is also used to render video content, typically by turning the player 110 to a landscape orientation so that the long axis of the display screen 218 is parallel to the ground.

The user controls 223, in this example, include a gesture pad 225, called a G-Pad, which combines the functionality of a conventional directional pad (i.e., a “D-pad”) with a touch sensitive surface as described in U.S. Patent Application Ser. No. 60/987,399, filed Nov. 12, 2007, entitled “User Interface with Physics Engine for Natural Gestural Control,” owned by the assignee of the present application and hereby incorporated by reference in its entirety having the same effect as if set forth in length. A “back” button 230 and “play/pause” button 236 are also provided. However, other types of user controls may also be used depending on the requirements of a particular implementation.

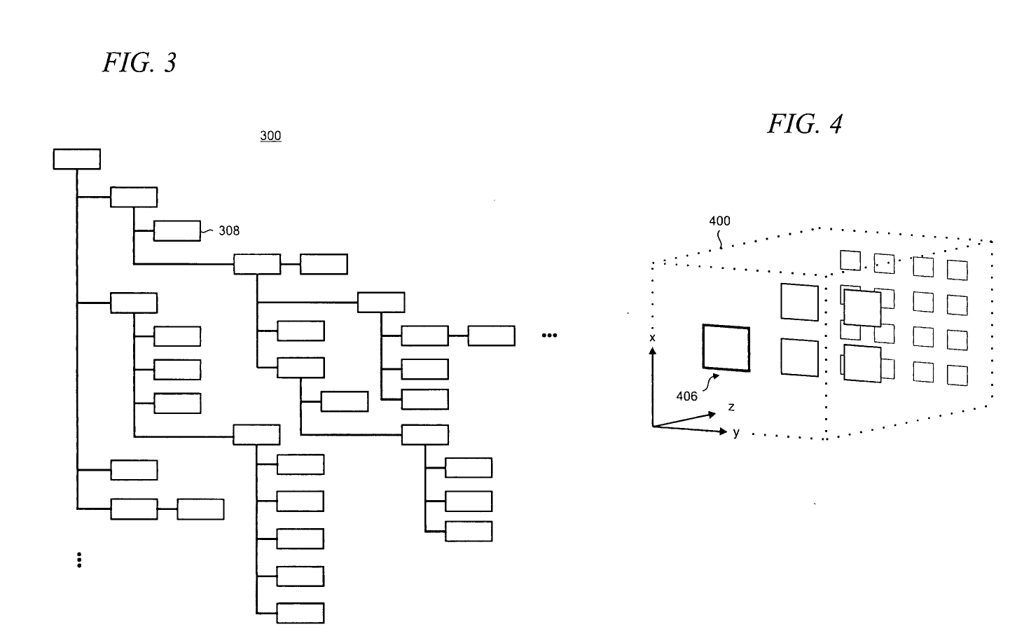

Conventional GUIs typically provide menus or similar paradigms to enable a user to manipulate the user controls 223 to make selections of media content, control operation of the portable media player 110, set preferences, and the like. The menus are generally arranged in a hierarchical manner, as represented by an illustrative hierarchy 300 shown in FIG. 3, with a representative menu item indicated by reference numeral 308. Hierarchies are commonly used, for example, to organize and present information and interactive experiences through which a user may make a selection from various options presented. Users will typically “drill down” a chain of related menus to reveal successive screens until particular content item or interactive experience is located.

While often effective, the hierarchical nature of such GUIs tends to compartmentalize the presentation of the GUI into discrete screens. The compartmentalization can often require that users move among one or more menus or go back and forth between menus to accomplish a desired action which may require a lot of interaction with the user controls 223. In addition, the GUI presentation tends to be “flat” in that it is typically organized using the two-dimensions of the display 218. To the extent that a third dimension is used, it often is implemented through the use of simple mechanisms such as pages (e.g., page 1 of 2, page 2 of 2, etc.). Overall, navigation in a hierarchically-arranged GUI can be non-intuitive and designers often face limitations in packaging the GUI content in order to avoid complex hierarchies in which users may easily get lost.

By comparison to flat, hierarchically-arranged menu, the present GUI with semantic zoom uses a virtual 3-D space. The 3-D space is virtually represented on the two-dimensional display screen 218 of the portable media player 110, but the user 105 may interact with it as if it had three dimensions in reality. An illustrative 3-D space 400 is shown in FIG. 4 that contains a multiplicity of GUI objects 406. The objects 406 are intended to represent any of a variety of GUI content that may be utilized when implementing a given system, such as media content, information, or interactive experiences. For example, the GUI objects 406 may include menu items, windows, icons, pictures, or other graphical elements, text, virtual buttons and other controls, and the like.

The GUI objects 406 may be located within the 3-D space 400 in any arbitrary manner, typically as a matter of design choice. In this example, the objects 406 are grouped in successive x-y planes in the 3-D space 400 along the z axis, but it is emphasized that such grouping is merely illustrative and other arrangements may also be used. However, in most cases, the 3-D space 400 will mimic real space so that GUI objects 406 that are further away (i.e., have a greater ‘z’ value) will appear to be smaller to the user 105 when represented on the display 218 of the portable media player 110.

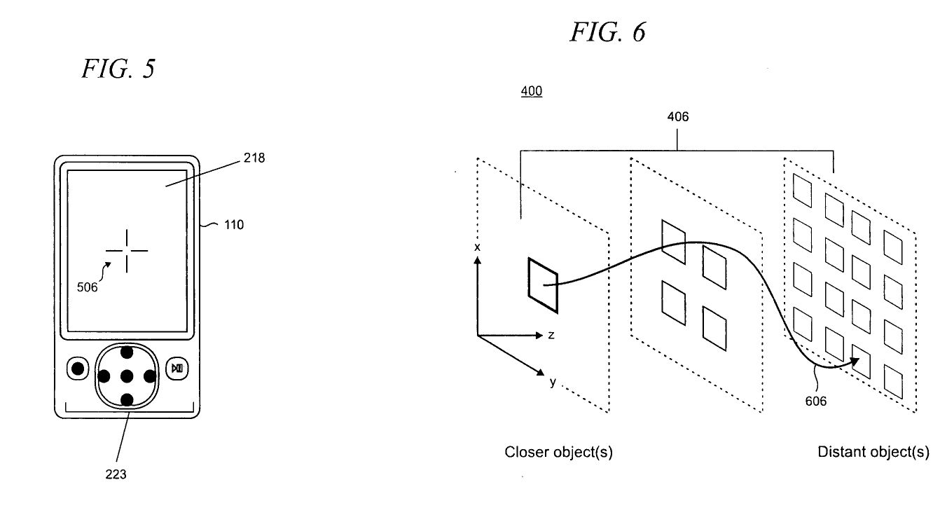

The user 105 may perform a semantic zoom in the 3-D space 400 through simple interaction with the user controls 223 on the portable media player 110. As shown in FIG. 5, these interactions will typically comprise pushes on the G-pad 225, as indicated by the black dots, in the center position, and the four directions of up, down, left, right. Pushes on the back button 230 may also be utilized, as described below, to back up along a path in the space. It is noted that the G-pad 225 is used as a conventional D-pad in this example. However, gestures supported by the touch sensitive portion of the G-pad 225 may also be utilized in alternative implementations.

The user can fly within the 3-D space 400, which is represented by apparent motion of the GUI objects 406 on the display screen 218, through actuation of the G-pad 225. A center push zooms ahead in a straight path, and the flight path can be altered by steering using up, down, left, or right pushes on the G-pad 225. The center of the display screen will typically be a reference point through which the flight path intersects, but it may be desirable to explicitly indicate this reference point by use of a cross hair 506, or similar marking.

As shown in FIG. 6, an illustrative flight path 606 for the semantic zoom goes between GUI objects 406 that are initially closer to the user and objects that are more distant. As the user steers the path 606 by manipulating the G-pad 225, as the semantic zoom is performed, the GUI objects 406 appear to move towards the user on the display screen 218 by getting larger as they get closer. Typically, the semantic zoom will occur at a constant rate (i.e., the apparent velocity in the ‘z’ direction will be constant). However, in alternative implementations, it may be desirable to enable acceleration and braking when flying in the 3-D space 400, for example through simultaneous pushes on the back button 230 (for braking) and the play/pause button 236 (for acceleration) while zooming and steering with the G-pad 225.

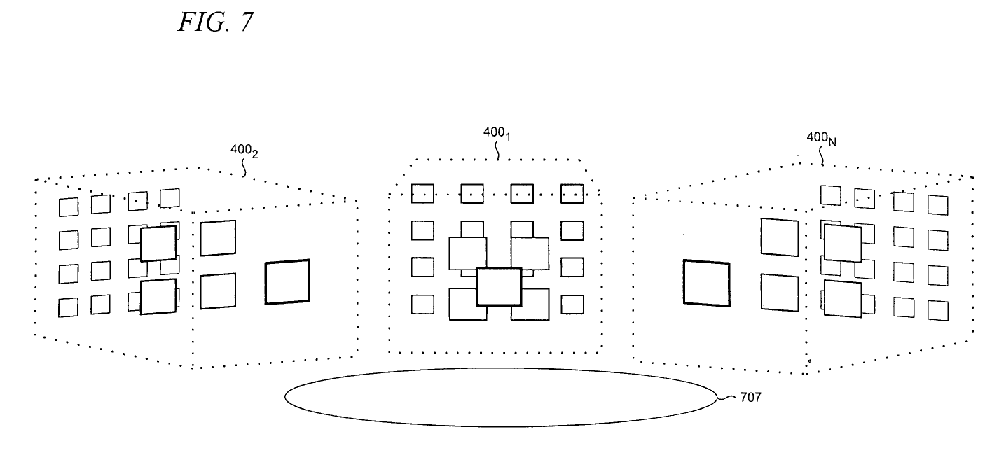

The present semantic zoom is not limited to a single 3-D space. Multiple 3-D spaces may be utilized in some scenarios. For example, as shown in FIG. 7, it may be advantageous to use separate 3-D spaces to support different GUIs for different purposes. Media content could be navigated in one 3-D space 400₁, while settings for the portable media player 110 could be effectuated using another 3-D space 400₂, while yet another 3-D space 400_{N} might be used to explore social interactions that are available through connections to other devices and players. Various methods such as different color schemes or themes could be used to uniquely identify the different 3-D spaces. The different 3-D spaces 702 may be entered through a common lobby 707, for example, which may be displayed on the player's display screen 218.

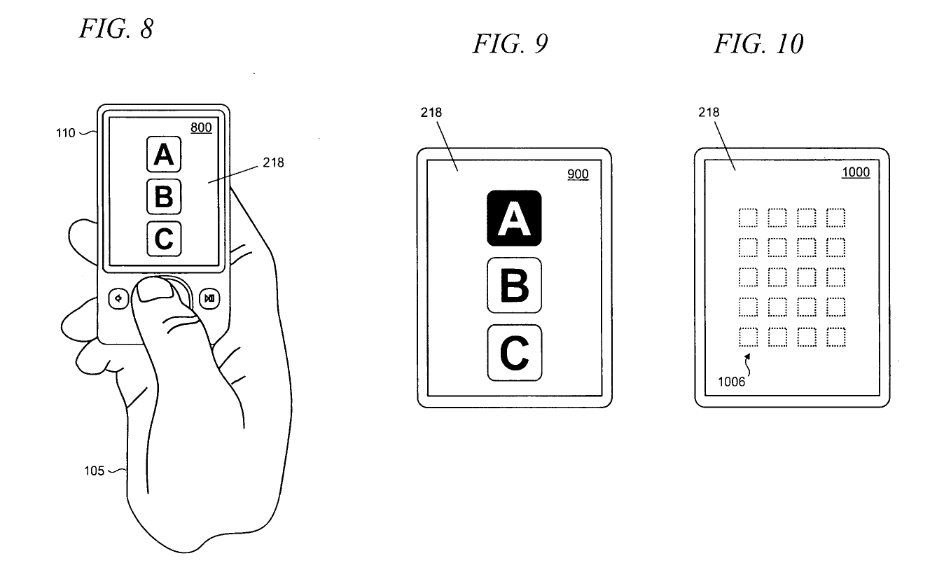

For a given 3-D space 400, the user 105 will typically enter the space at some high-level entry point, and then employ the semantic zoom to fly through the 3-D space to discover more detailed information. FIG. 8 is an illustrative screen shot 800 of the display screen 218 showing one such high-level entry point into a 3-D space 400. The high-level entry point in this example comprises a group of icons representing an alphabet that is used to access listings of music artists associated with media content that is stored on the portable media player 110 (or which may be otherwise accessed through the player). In this example, the alphabet icons are arranged as a scrollable list on the display screen 218. However, in alternative arrangements, icons for the entire alphabet may be displayed on a non-scrollable screen. It is emphasized that the use of an alphabet as the high-level entry point to a 3-D space is illustrative and that other types of entry points may also be used depending on the requirements of a given implementation.

In the screen 900 shown in FIG. 9, the user 105 has selected the letter ‘A’ to explore artists' names that begin with that letter. As the user 105 presses the G-pad 225 to zoom into the 3-D space 400, GUI objects 1006 appear in the distance as shown in screen 1000 in FIG. 10. As the user 105 continues to zoom in, the objects appear to get closer by increasing in size with more detail becoming apparent. As details become discernible, the user can use the directional positions on the G-pad 225 to steer up, down, left, or right as the zoom continues to steer to a GUI object or group of objects of interest.

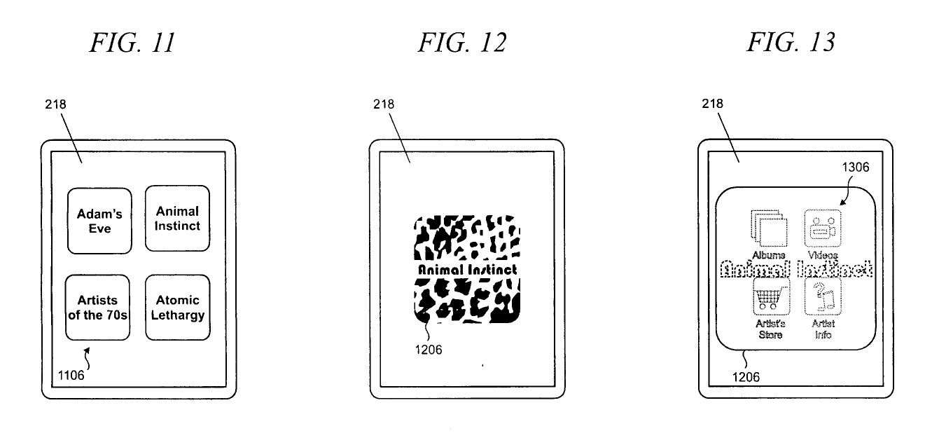

An illustrative group of GUI objects 1106 is shown in FIG. 11 which comprises four fictitious artists. As the user 105 continues to zoom and steer a path, more detailed information becomes available. As shown in FIG. 12, such details may include, for example, information such as representative graphics and logos 1206 for the band, descriptive text, and the like. Representative audio content, such as a sample of a hit or popular song from the artist, could also be rendered as the user 105 zooms in to a particular object that is associated with the artist.

The present semantic zoom provides a seamless user experience which also advantageously provides a context for the GUI objects in the 3-D space 400. That is, unlike hierarchically-arranged menus where users jump from menu to menu, the GUI objects are traversed in the 3-D space in a continuous manner so that a close object will provide context for the more distant objects that reveal more detailed information or interactive experiences. For example, as shown in FIG. 13, as the user 105 continues to zoom into the GUI object 1206, it will dissolve, or become increasingly transparent to reveal more distant GUI objects 1306 in the 3-D space with which the user may interact to get more details about the artist. However, it is emphasized that transparency is merely illustrative and that other techniques for providing semantic context may also be utilized. In most cases, the techniques will operate to show a connection between GUI objects, such as some form of simultaneous display of both objects on the display screen 218 or the like.

The semantic zoom is characterized by transitions between the close and distant GUI objects that are dependent on the context level of the zoom. For example, as the user 105 zooms in, graphics and/or text will continue to grow in size as they appear to get closer. At a certain point in the zoom, a meaningful transition (i.e., a semantic transition) occurs where such graphics and text can appear to dissolve (e.g., have maximum transparency) to give room on the display to show other GUI objects that represent more detailed information. These objects will be initially small but also continue to grow in size and appear to get closer as the user continues with the semantic zoom. Another semantic transition will then take place to reveal GUI objects representing even more detailed information, and so on. The semantic zoom operation is thus a combination of a traditional zoom feature with semantic transitions that occur at the interstices between related groups of GUI objects.

The semantic zoom enables a continuity of experience which lets the user 105 keep track of where he is located in the 3-D space without needing to manipulate a lot of user controls. Indeed, the zooming and manipulating is very intuitive and only requires steering with the G-pad 225. Referring back to FIG. 8, some users may wish the hold the portable media player 110 in one hand and steer with a thumb. Thus, navigating even large libraries of content can be done easily with very little input motion.

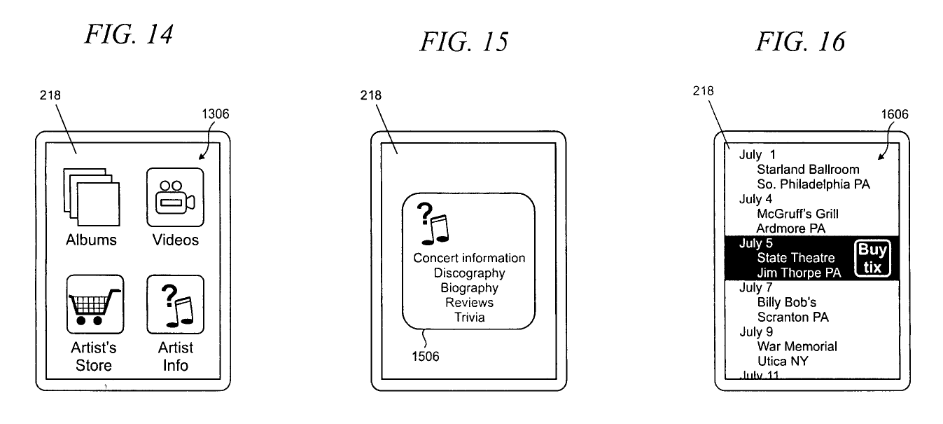

As the user 105 continues with the semantic zoom the GUI objects 1306 become more distinct as they draw closer, as shown in FIG. 14. The GUI objects 1306 in this example represent more detailed information about albums and videos (e.g., music videos) that the user 105 owns and has stored on the portable media player 110, or might otherwise be available. For example, media content may be available on the player 110 that may be rendered with a limited play count under an applicable DRM (digital rights management) scheme. Icons representing artist information and purchase opportunities via an electronic store are also shown to the user 105 on the display screen 218.

In this example, the user 105 steers to the artist information icon 1506, as shown in FIG. 15, which gets larger and reveals more details as the user zooms in. These details illustratively include such items as concert information, the artist's discography and biography, reviews by people within the user's social graph, trivia about the artist, and the like. Other details may include “rich” metadata associated with an artist or media content such as album cover artwork, artist information, news from live feeds, reviews by other consumers or friends, “bonus,” “box set,” or “extras” features, etc. For video content, the metadata may include, for example, interviews with the artists, actors, and directors, commentary, bloopers, behind the scenes footage, outtakes, remixes, and similar kinds of content.

If the user 105 continues to zoom in and steers to the concert information, a list of concert dates and venues 1606 will come into view, as shown in FIG. 16. Here, the user 105 may select a particular date and venue which triggers the display of a graphic 1612 to invite the user to purchase tickets to the event.

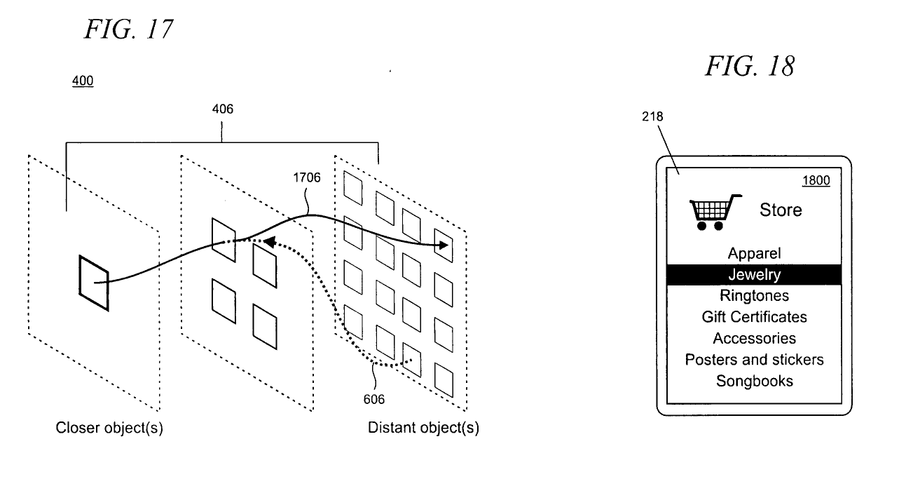

In the event that the user 105 wishes to move backwards in the 3-D space 400 to revisit a previous GUI object or steer a new path, by actuating the back button 230 on the player 110, he can back up along the previous semantic zoom path 606, as shown in FIG. 17. The GUI objects 406 shown on the display screen 218 will get smaller and recede from view to indicate the backwards motion to the user 105. Typically, to avoid needing to steer in reverse, the backing up will automatically trace the path 606 in a backwards direction. The user 105 can then steer a new path 1706 to another GUI object of interest 406 using the G-pad 225. In this example, the new destination GUI object is a menu 1800 for a store that is associated with the artist selected by the user 105.

It will be appreciated that the user experience shown in the illustrative example in FIGS. 9-18 and described in the accompanying text can be extended to cover additional detailed information and interactive experiences as may be required to meet the needs of a particular implementation and usage scenarios. In addition, the particular number and arrangement of GUI objects 406 shown and described is intended to be illustrative, and other numbers and arrangements may also be utilized.

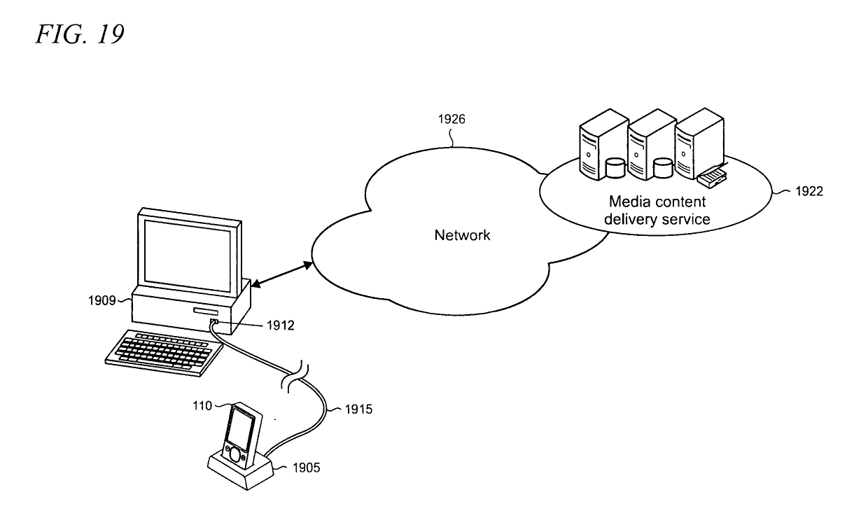

FIG. 19 shows the portable media player 110 as typically inserted into a dock 1905 for synchronization with a PC 1909. Dock 1905 is coupled to an input port 1912 such as USB port (Universal Serial Bus) with a synchronization (“sync”) cable 1915, in this example. Other arrangements may also be used to implement communications between the portable media player 110 and PC 102₁ including, for example, those employing wireless protocols such as Bluetooth, or Wi-Fi (i.e., the Institute of Electrical and Electronics Engineers, IEEE 802.11 standards family) that enable connection to a wireless network or access point.

In this example, the portable media player 110 is arranged to be operatively couplable with the PC 1909 using a synchronization process by which data may be exchanged or shared between the devices. The synchronization process implemented between the PC 1909 and portable media player 110 typically enables media content such as music, video, images, games, information, and other data to be downloaded from an on-line source or media content delivery service 1922 over a network 1926 such as the Internet to the PC 1909. In this way, the PC 1909 operates as an intermediary or proxy device between the service 1922 and the portable media player 110.

In addition to media content, GUI objects 406 that may be used as updates to the objects in a given 3-D space 400 may also be provided by the service 1922 in order to keep the GUI current with any newly downloaded content. The downloaded media content and/or updated GUI objects may then be transferred to the portable media player 110 from the PC 1909. Typically, the GUI objects from the service will be DRM-free, although various DRM methodologies may also be applied if desired.

A pair of mating connectors are utilized to implement the connection between the portable media player 110 and the dock 1905, where one of the connectors in the pair is disposed in the player (typically accessed through a sync port on the bottom of the player opposite the earphone jack 202) the and the other is disposed in the recess of the dock 206 in which the player sits. In this example, the connectors are proprietary and device-specific, but in alternative implementations standardized connector types may also be utilized.

The dock 1905 also typically provides a charging functionality to charge an onboard battery in the portable media player 110 when it is docked. It is noted that the sync cable 1915 may also be directly coupled (i.e., without the player being inserted into the dock 1905) to the portable media player 110 using the proprietary, device-specific connector at one end of the sync cable. However, the dock 1905 may generally be used to position the docked portable media player 110 so that the player's display 218 may be readily seen and the controls 223 conveniently accessed by the user 105.

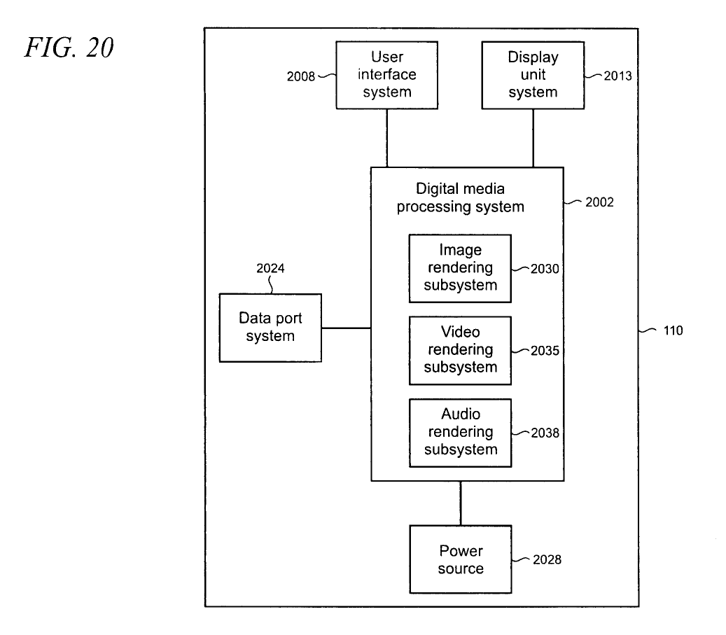

FIG. 20 a simplified block diagram that shows various illustrative functional components of the portable media player 110. The functional components include a digital media processing system 2002, a user interface system 2008, a display unit system 2013, a power source system 2017, and a data port system 2024. The digital media processing system 2002 further comprises an image rendering subsystem 2030, a video rendering subsystem 2035, and an audio rendering subsystem 2038.

The digital media processing system 2002 is the central processing system for the portable media player 110 and provides functionality that is similar to that provided by the processing systems found in a variety of electronic devices such as PCs, mobile phones, PDAs, handheld game devices, digital recording and playback systems, and the like.

Some of the primary functions of the digital media processing system 2002 may include receiving media content files downloaded to the player 110, coordinating storage of such media content files, recalling specific media content files on demand, and rendering the media content files into audio/visual output on the display for the user 105. Additional features of the digital media processing system 2002 may also include searching external resources for media content files, coordinating DRM protocols for protected media content, and interfacing directly with other recording and playback systems.

As noted above the digital media processing system 2002 further comprises three subsystems: the video rendering subsystem 2035 which handles all functionality related to video-based media content files, which may include files in MPEG ( Moving Picture Experts Group) and other formats; the audio rendering subsystem 2038 which handles all functionality related to audio-based media content including, for example music in the commonly-utilized MP3 format and other formats; and the image rendering subsystem 2030 which handles all functionality related to picture-based media content, including for example JPEG (Joint Photographic Experts Group), GIF (Graphic Interchange Format), and other formats. While each subsystem is shown as being logically separated, each may in fact share hardware and software components with each other and with the rest of the portable media player 110, as may be necessary to meet the requirements of a particular implementation.

Functionally coupled to the digital media processing system 2002 is the user interface system 2008 through which the user 105 may exercise control over the operation of the portable media player 110. A display unit system 2013 is also functionally coupled to the digital media processing system 2002 and may comprise the display screen 218 (FIG. 2). Audio output through the earphone jack 202 (FIG. 2) for playback of rendered media content may also be supported by display unit system 2013. The display unit system 2013 may also functionally support and complement the operation of the user interface system 2008 by providing visual and/or audio output to the user 105 during operation of the player 110.

The data port system 2024 is also functionally coupled to the digital media processing system 2002 and provides a mechanism by which the portable media player 110 can interface with external systems in order to download media content. The data port system 2024 may comprise, for example, a data synchronization connector port, a network connection (which may be wired or wireless), or other means of connectivity.

The portable media player 110 has a power source system 2017 that provides power to the entire device. The power source system 2017 in this example is coupled directly to the digital media processing system 2002 and indirectly to the other systems and subsystems throughout the player. The power source system 2017 may also be directly coupled to any other system or subsystem of the portable media player 110. Typically, the power source may comprise a battery, a power converter/transformer, or any other conventional type of electricity-providing power source, portable or otherwise.

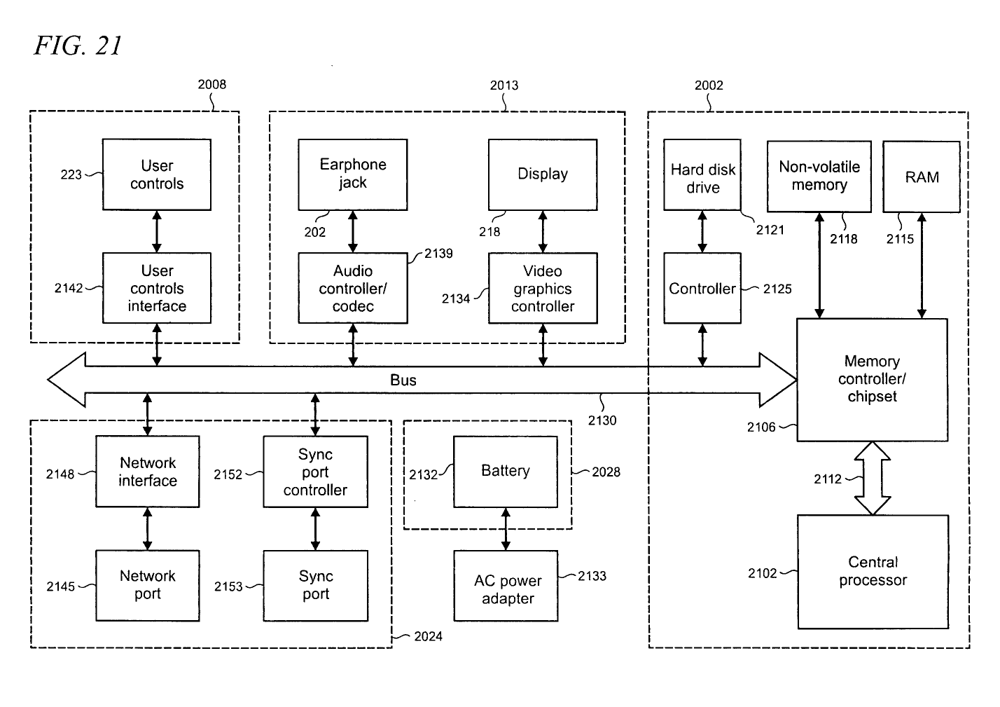

FIG. 21 is a simplified block diagram that shows various illustrative physical components of the portable media player 110 based on the functional components shown in FIG. 20 and described in the accompanying text (which are represented in FIG. 21 by dashed lines) including the digital media processing system 2002, the user interface system 2008, the display unit system 2013, the data port system 2024, and the power source system 2028. While each physical component is shown as included in only a single functional component in FIG. 21 the physical components may, in fact, be shared by more than one functional component.

The physical components include a central processor 2102 coupled to a memory controller/chipset 2106 through, for example, a multi-pin connection 2112. The memory controller/chipset 2106 may be, in turn, coupled to random access memory (“RAM”) 2115 and/or non-volatile memory 2118 such as flash memory. These physical components, through connectivity with the memory controller/chipset 2106, may be collectively coupled to a hard disk drive 2121 via a controller 2125, as well as to the rest of the functional component systems via a system bus 2130.

In the power supply system 2028, a rechargeable battery 2132 may be used to provide power to the components using one or more connections (not shown). The battery 2132, in turn, may also be coupled to an external AC power adapter 2133 or receive power via the sync cable 1915 when it is coupled to the PC 1909.

The display screen 218 is associated with a video graphics controller 2134. The video graphics controller will typically use a mix of software, firmware, and/or hardware, as is known in the art, to implement the GUI, including the present semantic zoom feature, on the display screen 218. Along with the earphone jack 436 and its associated audio controller/codec 2139, these components comprise the display unit system 2013 and may be directly or indirectly connected to the other physical components via the system bus 2130.

The user controls 223 are associated with a user control interface 2142 in the user interface system 2008 that implements the user control functionality that is used to support the interaction with the GUI as described above. A network port 2145 and associated network interface 2148, along with the sync port 2153 and its associated controller 2152 may constitute the physical components of the data port system 2024. These components may also directly or indirectly connect to the other components via the system bus 2130.

It will be appreciated that the principles of the present semantic zoom may be generally applied to other devices beyond media players. Such devices include, for example, mobile phones, PDAs, smart phones, handheld game devices, ultra-mobile computers, devices including various combinations of the functionalities provided therein, and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, implement a method for operating a GUI, the method comprising the steps of:
creating a virtual 3-D space in which a plurality of GUI objects may be populated, the GUI objects representing at least one of media content, information, data, or an interactive experience for a user of the GUI, the GUI objects being displayable on a 2-D display screen on the device;
supporting one or more user controls for interacting with the 3-D space so that by manipulating the controls, from a point of view on the display screen, the user may maneuver through the virtual 3-D space by zooming from close GUI objects to distant GUI objects, the close GUI objects providing a semantic construct for the distant GUI objects; and
enabling interaction with a GUI object to facilitate control over the device by the user.

2. The computer-readable medium of claim 1 in which the GUI objects are arranged in the 3-D space so that close GUI objects in the 3-D space represent high-level media content, information, data, or an interactive experience, and distant GUI objects represent detailed media content, information, data, or an interactive experience.

3. The computer-readable medium of claim 1 in which the manipulating comprises steering a path through the 3-D space by operating a user control which implements functionality of a directional pad.

4. The computer-readable medium of claim 3 including a further step of enabling traversal of the path in a reverse direction by manipulation of a user control that implements the functionality of a back button.

5. The computer-readable medium of claim 1 in which the interactive experience comprises a menu from which the user may make selections.

6. The computer-readable medium of claim 1 by which the semantic construct is implemented by simultaneous display of close and distant GUI objects.

7. The computer-readable medium of claim 6 in which the simultaneously displayed GUI objects are rendered with some degree of transparency, or appear to dissolve so as to implement a semantic transition between GUI objects, the semantic transition occurring in interstitial regions between related groups of GUI objects.

8. The computer-readable medium of claim 1 in which the device is one of mobile phone, PDA, media player, handheld game device, smart phone, ultra-mobile computer, or a device having a combination of functionalities provided therein.

9. The computer-readable medium of claim 1 including a further step of rendering at least a portion of an audio sample associated with a GUI object.

10. A method for providing a media content delivery service to a remote portable media player, the method comprising the steps of:
receiving a request to download media content from the media content delivery service;
supplying media content to an intermediary device in response to the request;
providing a GUI object that is associated with the supplied media content, the GUI object being usable in GUI supported by the portable media player in a virtual 3-D space in which a plurality of GUI objects are populated, each of the GUI objects representing at least one of media content, information, data, or an interactive experience for a user of the GUI; and
enabling the GUI object to be transferred from the intermediary device to the portable media player.

11. The method of claim 10 in which intermediary device is a PC and the GUI object is transferred during a synchronization process between the portable media player and the PC.

12. The method of claim 10 in which the GUI object comprises one of graphics, menu, menu item, text having an association with the media content.

13. The method of claim 10 in which the GUI object comprises rich metadata.

14. A portable media player, comprising:
a display screen configured for rendering text and graphics in 2-D;
user controls;
a digital media processing system interfacing with the display screen to render a GUI and digital media content in the form of images or video; and
memory bearing computer-readable instructions which, when executed by one or more processors in the portable media player i) implement the GUI on the display screen, the GUI comprising a plurality of GUI objects that are populated within a virtual 3-D space that is renderable on the display screen in 2-D, and ii) enable the user controls to be manipulated by the user to fly along a path through the 3-D space among the GUI objects using a semantic zoom process, the semantic zoom process supporting a user experience in which close GUI objects in the 3-D space provide contextual meaning for distant GUI objects in the 3-D space.

15. The portable media player of claim 14 in which the user controls comprise a D-pad supporting control actuation in a center direction, left direction, right direction, up direction, and down direction.

16. The portable media player of claim 14 in which the user controls comprise a G-pad comprising a switch and a touch sensitive surface, the G-pad replicating functionality of a D-pad by supporting control actuation in a center direction, left direction, right direction, up direction, and down direction.

17. The portable media player of claim 14 further including a synchronization port by which the portable media player may be synchronized with an intermediary device to obtain GUI objects from a remote service.

18. The portable media player of claim 14 in which the digital media processing system is configured for receiving media content, storing the media content, and rendering portions of the media content on the display screen.

19. The portable media player of claim 14 in which the manipulation comprises steering through the 3-D space.

20. The portable media player of claim 14 in which the manipulation comprises actuation of a back button among the user controls to traverse the path in a reverse direction.
